(19) United States
(12) Patent Application Publication
(10) Pub. No.: US 2025/0383826 A1
(43) Pub. Date: Dec. 18, 2025

(54) CONTROL METHOD, STORAGE MEDIUM, AND INFORMATION PROCESSING APPARATUS

(71) Applicant: CANON KABUSHIKI KAISHA, Tokyo (JP)

(72) Inventor: YASUKO KATO, Kanagawa (JP)

(21) Appl. No.: 19/220,372

(22) Filed: May 28, 2025

(30) Foreign Application Priority Data
Jun. 12, 2024 (JP) 2024-095372

(51) Int. Cl. G06F 3/12

(52) U.S. Cl. CPC G06F 3/1242; G06F 3/1208; G06F 3/121; G06F 3/1255

(57) ABSTRACT

A computer is caused to execute: arranging to perform hierarchical arrangement in which multiple objects are arranged in a hierarchical manner, setting an object arranged on a top hierarchy out of the multiple objects, on which the hierarchical arrangement is performed, as an upper object; and controlling a control not to allow a target object as an operation target to be operated out of the plurality of objects to overlap on top of at least a part of the upper object.

### BACKGROUND

### Field of the Technology

The present disclosure relates to a design application that supports creation of a printed material.

### Description of the Related Art

Recent years, a design application that supports creation of various printed materials has been utilized. The design application can create a user-oriented design by laying out multiple objects. Additionally, Japanese Patent Laid-Open No. H10-164351 discloses a technique of displaying an object with a reduced tone as the object is positioned lower than another object in a case where multiple objects overlap.

Improvement of the usability in the design application has been demanded.

### SUMMARY

A control method according to an aspect of the present disclosure is the control method causing a computer to execute: arranging to perform hierarchical arrangement in which a plurality of objects are arranged in a hierarchical manner; setting an object arranged on a top hierarchy out of the plurality of objects, on which the hierarchical arrangement is performed, as an upper object; and controlling a control not to allow a target object as an operation target to be operated out of the plurality of objects to overlap on top of at least a part of the upper object.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a configuration example of an information processing system;

FIG. 2 is a diagram illustrating an example of an object management table utilized in the information processing system in FIG. 1;

FIG. 3 is a flowchart describing process of adding a new object that is executed via a Web browser in FIG. 1;

FIG. 4 is a diagram illustrating an example of a Web application window displayed by the Web browser in FIG. 1;

FIG. 5 is a diagram illustrating an example of the Web application window in a case where a background object is laid out;

FIG. 6 is a diagram illustrating an example of the Web application window in a case where an image object is laid out on a poster on which the background object in FIG. 5 is laid out;

FIG. 7 is a diagram illustrating an example in which upper object setting of a layer in FIG. 6 is in a disabled state;

FIG. 8 is a diagram illustrating an example in which the upper object setting of the layer in FIG. 7 transitions from the disabled state to an enabled state in response to an operation of an upper object setting icon in FIG. 7;

FIG. 9 is a diagram illustrating an example of the Web application window in a case where a two-dimensional code is laid out on the poster on which the background object and the image object in FIG. 6 are laid out;

FIG. 10 is a diagram illustrating an example of the Web application window in a case where still another image is laid out on the poster on which the background, the image, and the two-dimensional code in FIG. 9 are laid out;

FIG. 11 is a diagram illustrating a display example of an upper object setting window;

FIG. 12 is a flowchart describing process of setting the upper object;

FIG. 13 is a diagram illustrating an example of a saving management table of the object laid out on the poster;

FIG. 14 is a diagram illustrating an example of the Web application window in the process of setting the upper object in FIG. 12;

FIG. 15 is a diagram illustrating an example in which the upper object setting of the layer transitions to the enabled state;

FIG. 16 is a diagram illustrating a display example of an error dialog box;

FIG. 17 is a flowchart describing process of changing the overlapping order of the object;

FIG. 18 is a diagram illustrating an example of the Web application window in the changing process in FIG. 17;

FIG. 19 is a diagram illustrating a changing example of the overlapping order of each object;

FIG. 20 is a diagram illustrating a display example of an error dialog box;

FIG. 21 is a diagram illustrating a display example of an error dialog box;

FIG. 22 is a diagram illustrating a changing example of the overlapping order of each object;

FIG. 23 is a flowchart describing confirmation process before printing execution of the poster;

FIG. 24 is a diagram illustrating an example of the Web application window in a case of printing execution of the poster; and

FIG. 25 is a diagram illustrating a display example of an error dialog box.

### DESCRIPTION OF THE EMBODIMENTS

Preferred embodiments of the present disclosure are described below in detail with reference to the appended drawings. Note that, the following embodiments are not intended to limit the matters of the present disclosure, and not all the combinations of the characteristics described in the following embodiments are necessarily required for the means for solving the problems of the present disclosure. Note that, the same constituents are provided with the same reference numerals.

### Embodiments

### <Overview>

Recent years, a design application that supports creation of various printed materials has been utilized. The design application can create the printed material such as a poster and a flyer by laying out and compositing images, two-dimensional codes (for example, a QR code (registered trademark)), and the like as objects on a single canvas. Further, text such as characters and sentences can be input the object as appropriate. Therefore, the user can use the design application to create a design in which a desired images and text are freely laid out and can print the design. However, when the user was editing objects, the objects would overlap, and printing would be performed without the user realizing that important information included in the underlying object was lost. On the other hand, there has also been disclosed a technique that makes it possible to recognize information included in each object, even in a case where the objects overlap with each other, by lowering the gradation of the object as a set display order decreases. According to the technique, prevention of the loss of information has been achieved even in a case where other objects overlay on top of the object including the important information. However, in the technique, the information included in each object is displayed with a different gradation from the actual object. For this reason, the display is different from the design assumed by the user, and it is unfavorable as the design application from the standpoint of intuitive operability. Therefore, in the present disclosure, control is performed not to allow a target object to be operated out of the plurality of objects to overlap on top of at least a part of the upper object. According to the control as described above, it is possible to prevent the object including the important information from being hidden by another object while maintaining the design assumed by the user. Accordingly, the present disclosure can improve the usability in the design application. To be more specific, the present disclosure can implement the intuitive operability and prevention of the loss of information. Hereinafter, in the embodiment, a method of switching display according to whether there is the object (hereinafter, referred to as the upper object as appropriate) fixed on top of the other object in the poster in a case where the user edits the poster is described. Thus, it is possible to prevent the object newly arranged by the user or the object with a changed overlapping order from overlapping with the object including the important information.

### <Information Processing System>

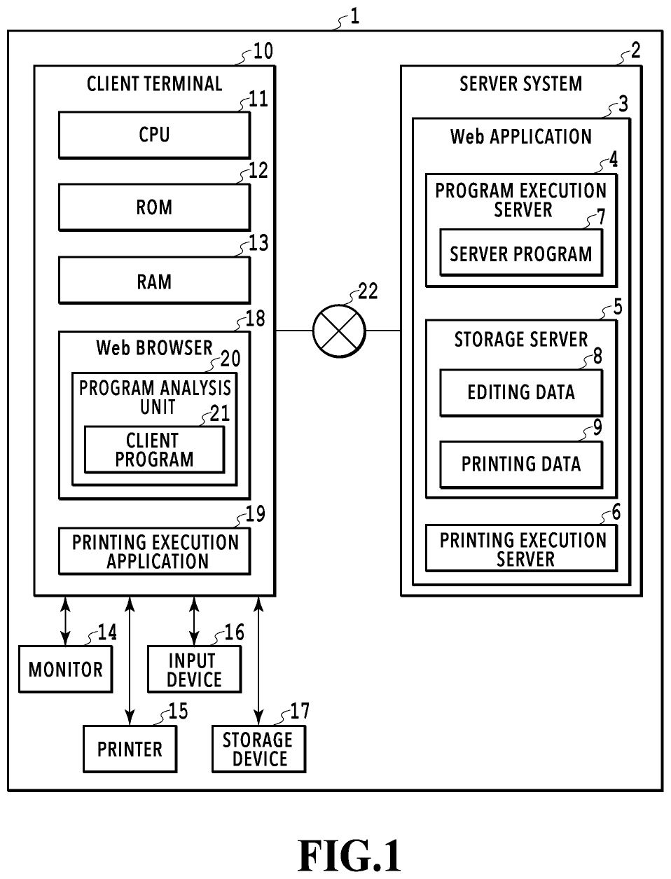

FIG. 1 is a diagram illustrating a configuration example of an information processing system 1. The information processing system 1 includes a client terminal 10 and a server system 2. The client terminal 10 and the server system 2 can be connected to each other by a network 22 such as the Internet. First, a configuration of the server system 2 is described with reference to FIG. 1. The server system 2 includes a Web application 3. The server system 2 performs process of various servers in the Web application 3. The server system 2 includes a program execution server 4, a storage server 5, and a printing execution server 6 as the various servers. The program execution server 4 executes a server program 7 that is a program operating on the server system 2. The storage server 5 saves editing data 8 and printing data 9 such as an image file and a printing data file in the Web application 3. The printing execution server 6 transmits the printing data 9 to a printing execution application 19 included in the client terminal 10 and performs printing. The program execution server 4, the storage server 5, and the printing execution server 6 may be implemented by physically different apparatuses or may be implemented as a single apparatus. Alternatively, each of the program execution server 4, the storage server 5, and the printing execution server 6 may be configured to be implemented as a cloud service. Note that, at least one of the editing data 8 and the printing data 9 is referred to as Web data as appropriate.

Next, a configuration of the client terminal 10 is described with reference to FIG. 1. The client terminal 10 is an information processing apparatus. The client terminal 10 is formed of a general personal computer or smartphone. The personal computer may be a desktop computer, a portable laptop computer, or a tablet terminal. The client terminal 10 includes a CPU 11, a ROM 12, and a RAM 13. Additionally, an input and output interface (not illustrated) for connection with a monitor 14, a printer 15, an input device 16, a storage device 17, and the network 22 such as the Internet is included. Note that, the printer 15 may be connected to the client terminal 10 via the network 22. The CPU 11 is a central processing unit, and controls overall the client terminal 10 by executing an OS stored in the storage device 17, the ROM 12, and the RAM 13.

Additionally, the CPU 11 executes a Web browser 18, a printing execution application 19, and other programs stored in the ROM 12 and the RAM 13. With the above-described process, the CPU 11 performs computation based on inputted data, processes and outputs the data, and controls each piece of hardware to implement each function of the client terminal 10. The ROM 12 is a read-only memory that stores each program. The RAM 13 is a random access memory used as a working memory of the CPU 11 and can store each program as long as it is a non-volatile RAM. The Web browser 18 browses a Website on the Internet or executes the Web application 3 provided from the server system 2. In a case where the Web application 3 is executed, a client program 21 is received from the server system 2 and executed by a program analysis unit 20 that construes a script language such as HTML and JavaScript. The printing execution application 19 transmits the printing data 9 of the server system 2 to the printer 15 connected to the client terminal 10 directly or via the network 22, and printing is performed.

### <Web Application>

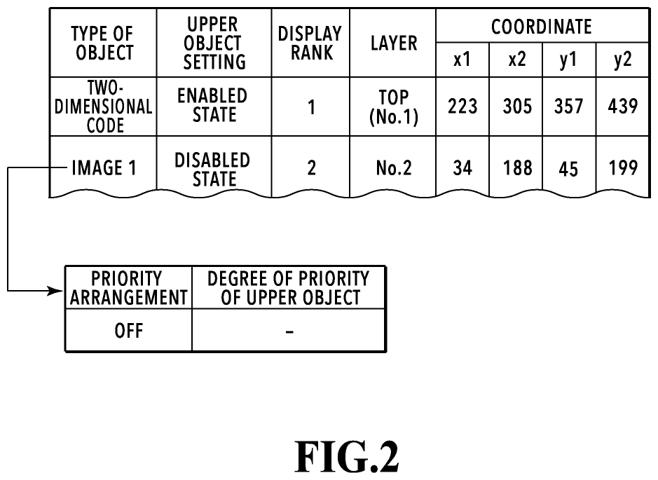

Next, process of the Web application 3 in FIG. 1 is described with reference to FIGS. 2 to 11. The Web application 3 functions as the design application. The design application performs hierarchical arrangement in which the multiple objects are arranged in a hierarchical manner. The object is, for example, the image or the two-dimensional code, which is a component of a design for printing that can be laid out and edited on an editing window displayed on a Web application window described later. The design for printing is any type of design assumed to be printed. The design for printing includes, for example, posters, flyers, pamphlets, business cards, letterheads, postcards, books, magazines, catalogs, reports, proposals, and so on. A data configuration of the object may be raster images or may be vector images. In the present embodiment, a poster production application is described as an example of a use case of the Web application 3.

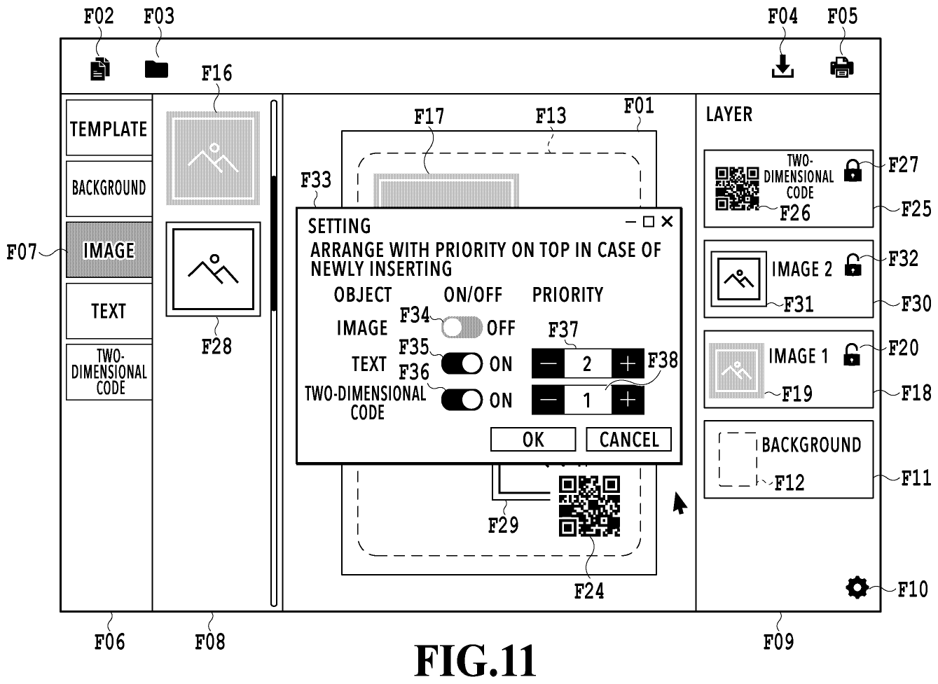

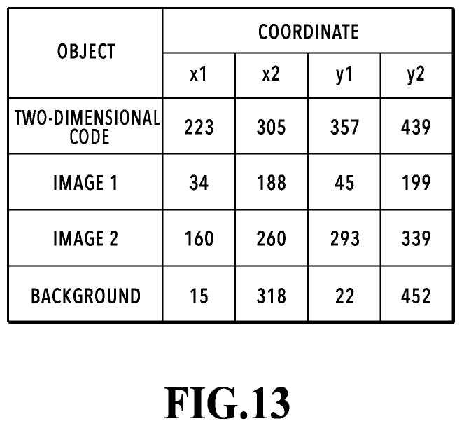

FIG. 2 is a diagram illustrating an example of an object management table utilized in the information processing system 1 in FIG. 1. In the example in FIG. 2, the two-dimensional code and “image 1” are illustrated as a type of the object, for example. In a case where the type of the object is the two-dimensional code, upper object setting is in an enabled state. On the other hand, in a case where the type of the object is “image 1,” the upper object setting is in a disabled state in the example in FIG. 2. Additionally, the display rank of the object of the two-dimensional code (hereinafter, referred to as a two-dimensional code object as appropriate) is set to first place, and the display rank of the object of “image 1” is set to second place. Accordingly, as the hierarchical arrangement in which the multiple objects are arranged in a hierarchical manner, a layer of the two-dimensional code object is set as the top (first place), and a layer of the object of “image 1” is set as second place. That is, the two-dimensional code object is set to be more upper level than the object of “image 1.” Therefore, even in a case where the object of “image 1” is tried to be overlapped on top of the two-dimensional code object, this editing operation is not allowed. In other words, in the Web application 3, the object that is arranged at the top hierarchy out of the multiple objects, on which the hierarchical arrangement is performed, is set as the upper object. Additionally, in the Web application 3, control is performed such that the target object as the operation target out of the plurality of objects is not allowed to be overlapped on top of at least a part of the upper object. Note that, as illustrated in FIG. 2, a coordinate of the two-dimensional code object is set, and a coordinate of the object of “image 1” is also set. With the setting of the coordinate as described above, it is possible to determine whether regions of the two objects overlap with each other; details are described with reference to FIG. 13. Moreover, the object of “image 1” may be associated with priority arrangement and a degree of priority of the upper object. Details are described later with reference to FIG. 11.

### (Process of Adding New Object)

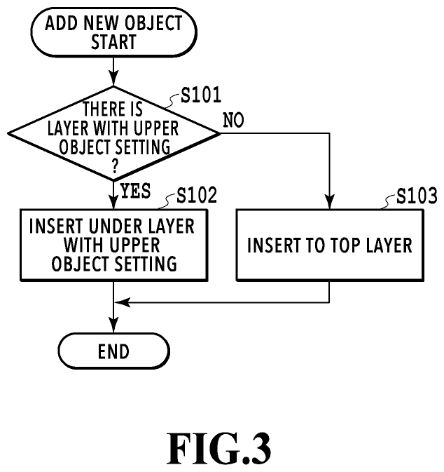

FIG. 3 is a flowchart describing process of adding a new object that is executed via the Web browser 18 in FIG. 1. The process of adding the new object is process of newly inserting the object via an operation by the user on the editing window. Here, a use case in which the user drags and drops an arbitrary object on the editing window and inserts a new layer as process in a case where the new layer is inserted is assumed. Additionally, the process illustrated in FIG. 3 is implemented with the CPU 11 reading out the program stored in the ROM 12 to the RAM 13 to execute. Specifically, the process illustrated in FIG. 3 is implemented with the CPU 11 reading out the client program 21 to execute. More specifically, the process illustrated in FIG. 3 is executed in a timing in which the user performs an operation to start process via the Web browser 18. Note that, a part of or all the functions of the steps in FIG. 3 may be implemented with hardware such as an ASIC or an electronic circuit. A sign “S” in description of each process means that it is a step in the corresponding flowchart. Additionally, it is possible to implement the process illustrated in FIG. 3 as a configuration of cloud computing in which a single function is shared by multiple resources and processed together via the Internet as long as the process of newly inserting the object is implemented.

In S101, the CPU 11 determines whether there is the layer to which the upper object is set. If there is the layer to which the upper object is set, the CPU 11 proceeds from the process in S101 to the process in S102. For example, in a case where the upper object setting of the two-dimensional code object is in the enabled state as illustrated in FIG. 2, in S102, the CPU 11 inserts the new object under the layer to which the upper object is set and terminates the processing. In other words, in a case where editing of one of the plurality of objects is started as the new object in a state where the upper object is set, the CPU 11 inserts the new object under the upper object. On the other hand, if there is no layer to which the upper object is set, the CPU 11 proceeds from the process in S101 to the process in S103. For example, in a case where there is no object with the upper object setting in the enabled state as illustrated in FIG. 2, in S103, the CPU 11 inserts the new object to the top layer and terminates the processing.

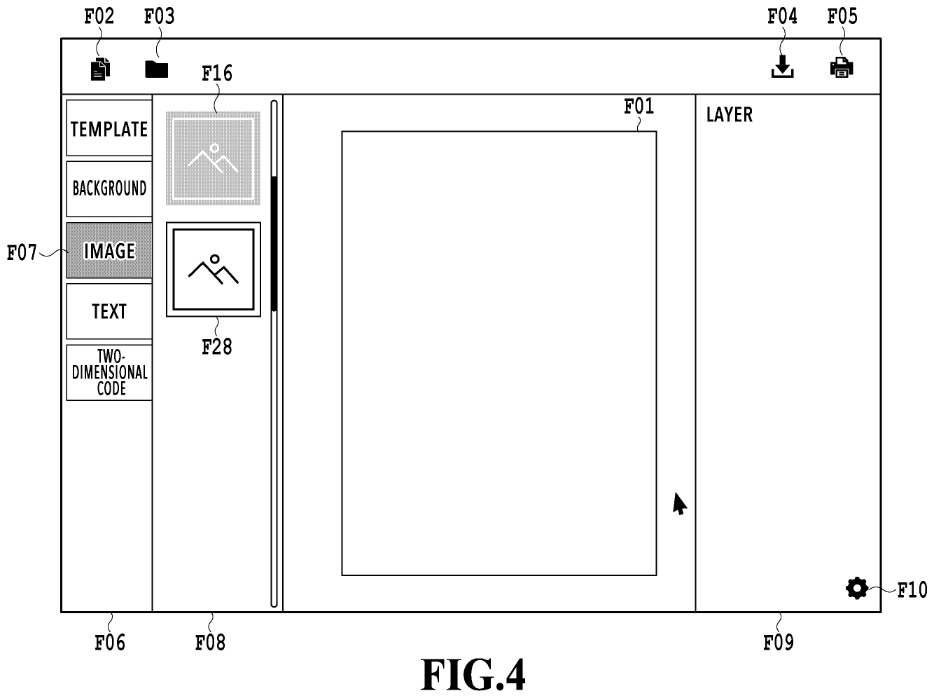

Next, a specific example in which the new object is inserted by the Web browser 18 in FIG. 1 is described. FIG. 4 is a diagram illustrating an example of the Web application window displayed by the Web browser 18 in FIG. 1. In FIG. 4, a use case in which the printing data 9 is edited via the Web application window is assumed. Note that, although operating various icons or objects displayed on the Web application window is described below as pressing, the operation is not limited to pressing. For example, single-clicking or double-clicking the various icons or objects displayed on the Web application window may be operating the icons or objects. Alternatively, single-tapping or double-tapping the various icons or objects displayed on the Web application window may be operating the icons or objects. A preview pane F01 of the poster is displayed in substantially the center of the Web application window in FIG. 4. The preview pane F01 displays a preview of the poster that the user is currently editing. Above the preview pane F01, buttons F02, F03, F04, and F05 are arranged as icons for operating the Web application window. The button F02 is the icon for instructing the creation of a new poster. In response to the pressing of the button F02, the creation of the poster is started. The button F03 is the icon for instructing to open existing poster data. In response to the pressing of the button F03, a user interface for selecting existing poster data is opened. The poster data is, for example, data saved as one of the printing data 9 in the storage server 5. Alternatively, the poster data may be data saved in a local folder of the user or the various servers included in the Web application 3. The button F04 is the icon for saving the poster being edited. In response to the pressing of the button F04, the poster being edited is saved in the local folder of the user or the various servers included in the Web application 3. The button F05 is the icon for instructing to print the poster. In response to the pressing of the button F05, the Web application 3 installs or activates the printing execution application 19, and it is possible to perform printing. An area F08 is formed on a left side of the preview pane F01 of the poster. An area F06 is formed on a left side of the area F08. In the area F06, the icons each corresponding to the type of the object to be added to the poster are arranged along a vertical direction. Therefore, the user can select an arbitrary object from the types of the objects displayed in the area F06. In the example of FIG. 4, an “image” icon formed as a button F07 is in a selected state. Area F08 displays the contents of the object selected in the area F06. In the example of FIG. 4, the “image” icon of the button F07 is in the selected state, so that a list of images held by the Web application 3 is displayed. An area F09 is formed on a right side of the preview pane F01 of the poster. The area F09 displays the object to be arranged in the poster and the overlapping order of the object, and the object with a higher overlapping order is displayed higher on the Web application window. The overlapping order of the object is to be displayed as the hierarchy including the object by each layer; details of the overlapping order of the object is described later. The icon of setting of the layer formed as a button F10 is arranged in lower right of the area F09. In response to the pressing of the button F10, the Web application 3 opens an upper object setting window described later and accepts changing of the setting.

In this manner, the Web application 3 to be executed on the information processing system 1 performs first display control for displaying the Web application window as illustrated in FIG. 4 based on various types of Web data provided and acquired from the server system 2. The first display control performs the hierarchical arrangement in which the plurality of objects are arranged in a hierarchical manner. The hierarchical arrangement is a process of creating a hierarchy in which the layer including the object is set for each object and the set layers are stacked in order. The first display control sets the object that is to be arranged on the top hierarchy out of the plurality of objects on which the hierarchical arrangement is to be performed, as the upper object. Additionally, the Web application 3 to be executed on the information processing system 1 performs second display control for updating display of the Web application window based on contents of the operation on the Web application window. The second display control performs the control not to allow the target object as the operation target to be operated out of the plurality of objects to overlap on top of at least a part of the upper object. Next, details of the second display control are described.

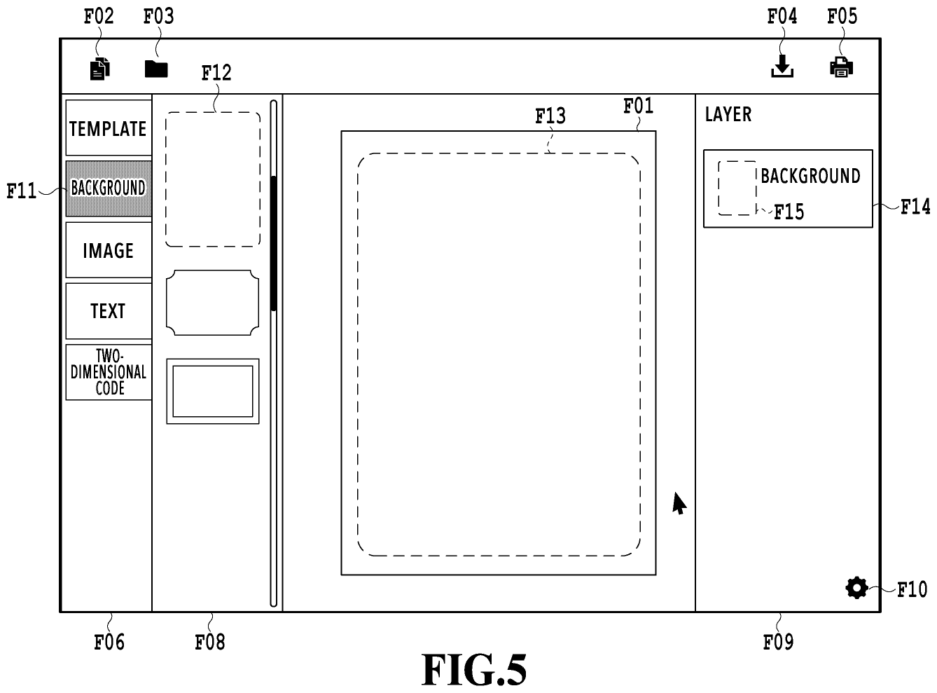

FIG. 5 is a diagram illustrating an example of the Web application window in a case where a background object is laid out. As illustrated in FIG. 5, a “background” icon of a button F11 is selected by the user in the area F06. The area F08 displays the contents of the “background” icon selected in the area F06. Specifically, images such as a thumbnail F12 and the like are displayed in thumbnail form as a list of backgrounds held by the Web application 3. The preview pane F01 displays contents of an object F13. The object F13 is the background object laid out on the poster in response to the pressing of the thumbnail F12. A layer F14 is arranged in the area F09. The layer F14 represents the hierarchy in which the object F13 is included, and includes a thumbnail F15. The thumbnail F15 is a thumbnail image of the background object. The background object is the object to be assumed that the object is the image object or the like which is to be laid out on the higher hierarchy than the layer F14. Therefore, the layer F14 does not include an upper object setting icon described later and is not set as the upper object. Next, the Web application window in a case where the image object is laid out on the poster on which the background object in FIG. 5 is laid out is described.

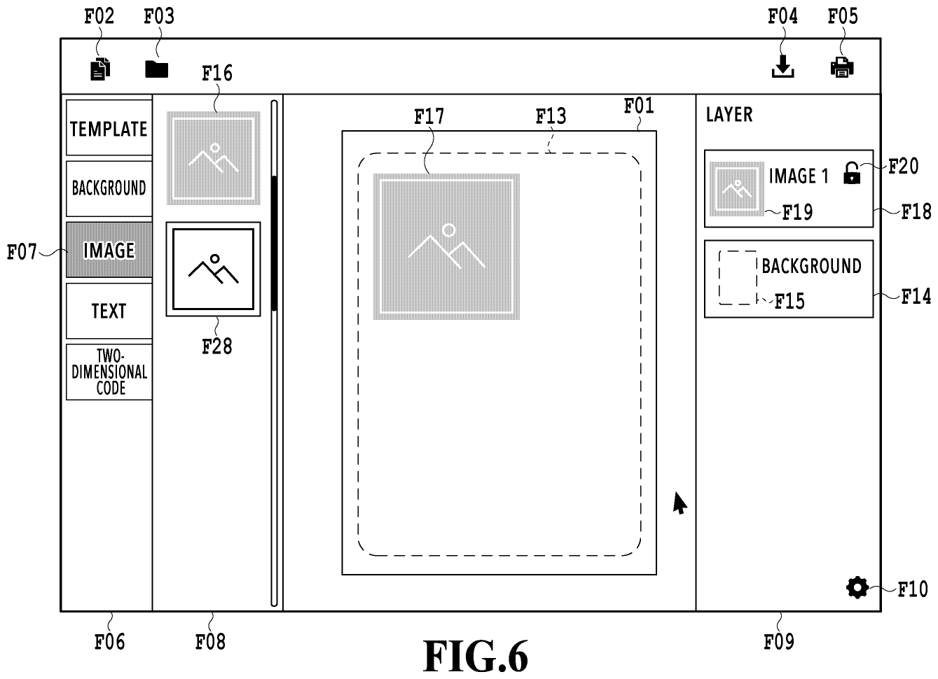

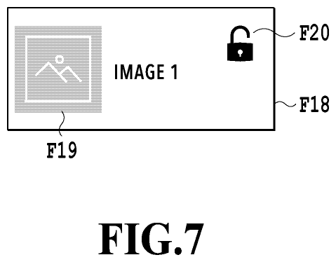

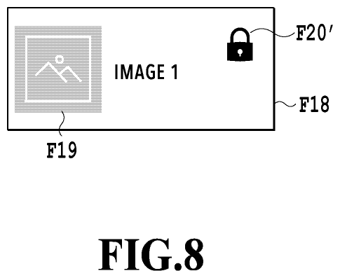

FIG. 6 is a diagram illustrating an example of the Web application window in a case where the image object is laid out on the poster on which the background object in FIG. 5 is laid out. The “image” icon of the button F07 is selected in the area F06. The area F08 displays the contents of the “image” icon selected in the area F06. Specifically, as a list of the images held by the Web application 3, images of a thumbnail F16 and a thumbnail F28 are displayed in thumbnail form. An object F17 is arranged on the preview pane F01. The object F17 is the image object laid out on the poster in response to the pressing of the thumbnail F16. A layer F18 and the layer F14 are arranged in the area F09. The layer F18 represents the hierarchy in which the object F17 is included, and includes a thumbnail F19 and an upper object setting icon F20. The thumbnail F19 is arranged in the left of the icon indicating the layer F18. The thumbnail F19 displays the image of the object F17 in thumbnail form. The upper object setting icon F20 is arranged in a right of the icon indicating the layer F18. The upper object setting icon F20 is displayed as the image imitating a state in which a padlock is unlocked, for example. In a case where the object F17 is laid out on the poster, the layer is inserted to the top of an existing object group except a case where the upper object described later is set. Therefore, in response to the pressing of the thumbnail F16, the layer F18 is inserted to be placed on top of the layer F14. The upper object setting icon F20 of the layer F18 represents whether the layer F18 is set as the upper object. FIG. 6 illustrates a state in which the layer F18 is not set as the upper object. That is, the upper object setting of the layer F18 is set in the disabled state. With the upper object setting icon F20 being pressed, the layer F18 is to be set as the upper object, and it is possible to apply the process related to the upper object that is described later. Next, display of the enabled state and the disabled state of the upper object setting is described with reference to FIGS. 7 and 8.

FIG. 7 is a diagram illustrating an example in which the upper object setting of the layer F18 in FIG. 6 is in the disabled state. In response to the pressing of the upper object setting icon F20, the upper object setting of the layer F18 transitions from the disabled state to the enabled state. FIG. 8 is a diagram illustrating an example in which the upper object setting of the layer F18 in FIG. 7 transitions from the disabled state to the enabled state in response to the pressing of the upper object setting icon F20 in FIG. 7. In the example in FIG. 8, the fact that the upper object setting is set in the enabled state is indicated as an upper object setting icon F20′. The upper object setting icon F20′ is displayed as the image imitating a state in which a padlock is locked, for example. In this manner, in a case where the upper object setting transitions from the disabled state to the enabled state, display is switched as the upper object setting icon F20′ in FIG. 8. Additionally, in response to the pressing of the upper object setting icon F20′ and enabling of the upper object setting of the layer F18, the process of setting the upper object that is described later is executed.

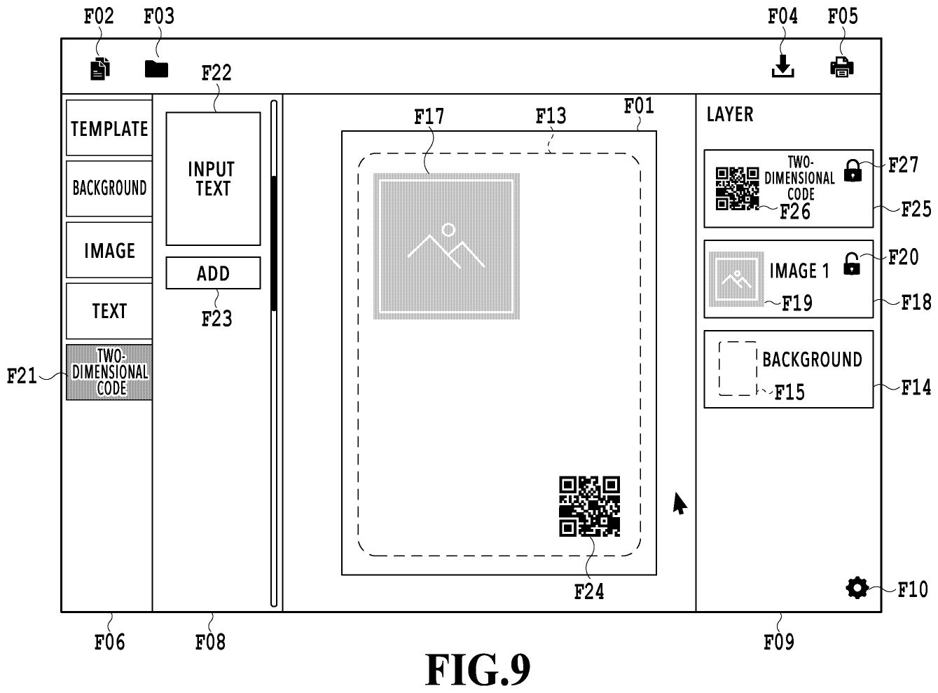

FIG. 9 is a diagram illustrating an example of the Web application window in a case where the two-dimensional code is laid out on the poster on which the background object and the image object in FIG. 6 are laid out. A “two-dimensional code” icon of a button F21 is selected by the user in the area F06. The area F08 displays the contents of the “two-dimensional code” icon selected in the area F06. Specifically, the area F08 displays a text box F22 and a button F23. The text box F22 is a region for inputting a URL which is to be converted into the two-dimensional code. The button F23 is the icon for adding the two-dimensional code to the poster. An object F24 is arranged in lower right of the preview pane F01 of the poster. The object F24 is the two-dimensional code object obtained by converting the text inputted to the text box F22 into the two-dimensional code and laying out the two-dimensional code on the poster in response to the pressing of the button F23. In response to the pressing of the button F23, a layer F25 is inserted to be placed on top of the layer F18 in the area F09. The layer F25 represents the hierarchy in which the object 24 is included, and includes a thumbnail F26 and an upper object setting icon F27. The thumbnail F26 displays the image of the object F24 in thumbnail form. In FIG. 9, the layer F25 indicates that the upper object setting is in the enabled state. Since the overlapping of the other object on top of the two-dimensional code object affects reading thereof, the two-dimensional code object is set as the upper object by default in a case of laying out. Thus, the process related to the upper object that is described later is applied to the layer F25. That is, depending on the type of each of the plurality of objects, whether to set the object as the upper object is determined. Note that, the upper object setting of the layer F25 is to be canceled by pressing the upper object setting icon F27.

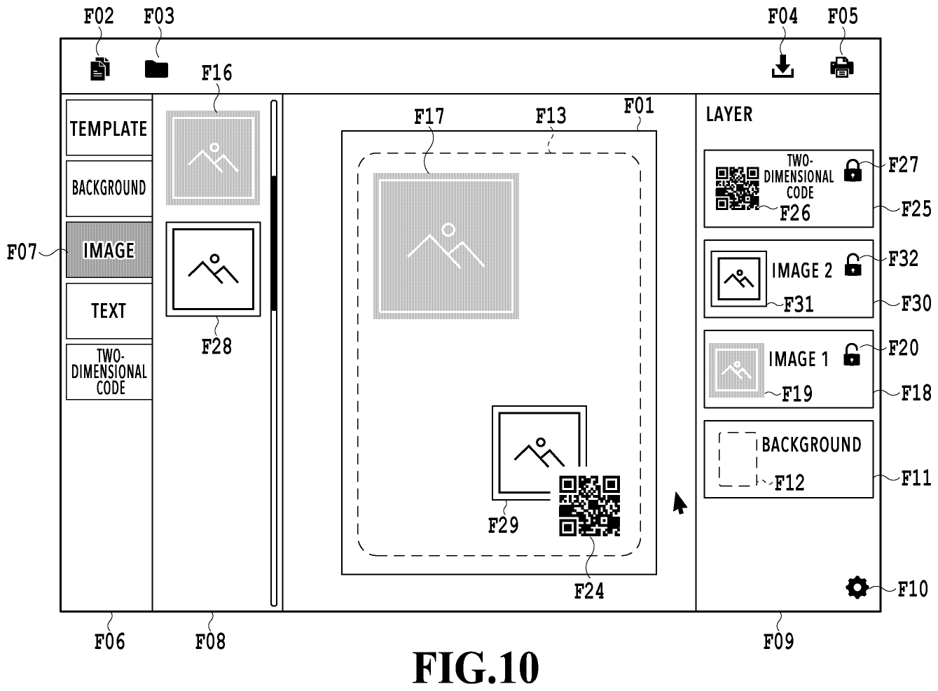

FIG. 10 is a diagram illustrating an example of the Web application window in a case where still another image is laid out on the poster on which the background, the image, and the two-dimensional code in FIG. 9 are laid out. The “image” icon of the button F07 is selected in the area F06. The contents of the “image” icon selected in the area F06 are displayed in the area F08. Specifically, as the list of the images held by the Web application, the area F08 displays the images of the thumbnail F16 and the thumbnail F28 in thumbnail form. An object F29 is arranged in lower right of the preview pane F01. The object F29 is the image object laid out on the poster in response to the pressing of the thumbnail F28. A layer F30 represents the hierarchy in which the object F29 is included, and includes a thumbnail F31 and an upper object setting icon F32. The thumbnail F31 displays the image of the object F29 in thumbnail form. In response to the pressing of the thumbnail F28, the layer F30 is inserted to be placed under (also referred to as a lower layer) the layer F25 set as the upper object in the area F09. In this manner, a state in which no object overlaps on top of the layer F25 set as the upper object is maintained. In other words, as the control not to allow the target object as the operation target to overlap on top of at least a part of the upper object, the CPU 11 rejects the editing operation to overlap on top of at least a part of the upper object to be performed on the target object. In this case, to overlap means the other object overlaps on top of one object. In terms of hierarchy, it means that the following state is obtained under the assumption that the other layer overlaps on top of one layer in the example in FIG. 10. That is, it means that at least a part of a region of the other object included in the other layer overlaps on top of at least a part of a region of the object included in one layer. In the design application, in a case where a single layer includes a single object, once a plurality of layers overlap with each other, those layers appear visually as a single image formed of the plurality of objects in planar view. For example, in the example in FIG. 10, the layers F11, F18, F30, and F25 overlap with each other from the lower to higher hierarchies, and thus the image formed of the objects F13, F17, F29, and F24 is formed in planar view. In this case, although a part of a region of the object F24 overlaps on top of a part of a region of the object F29, there is no problem because the object F24 is set as the upper object.

In the above-described embodiment, whether it is the upper object is switched automatically depending on the type of the object in a case of inserting the object; however, the object treated as the upper object may be set in advance manually. FIG. 11 is a diagram illustrating a display example of an upper object setting window F33. In FIG. 11, the upper object setting window F33 is displayed above the preview pane F01 of the poster. The upper object setting window F33 is a setting window that is to be opened in response to the pressing of the button F10 arranged in lower right of the area F09. The upper object setting window F33 includes toggle buttons F34, F35, and F36 and degree-of-priority input forms F37 and F38. The toggle buttons F34, F35, and F36 are buttons to set whether to insert the object as the upper object in a case of newly inserting. In the example in FIG. 11, setting of the image object corresponds to the toggle button F34, setting of the text object corresponds to the toggle button F35, and setting of the two-dimensional code object corresponds to the toggle button F36. In FIG. 11, the text object and the two-dimensional code object are set to be treated as the upper object in a case of newly inserting. The degree-of-priority input forms F37 and F38 are forms to set the degree of priority of the upper object. The degree-of-priority input forms F37 and F38 are displayed in response to the fact that the toggle buttons F35 and F36 are turned on. In FIG. 11, the degree of priority is set in the order from the two-dimensional code object and then the text object. Therefore, the two-dimensional code object is set as the upper object with the top hierarchy out of the plurality of objects. Therefore, in a case where the object is inserted, the object is inserted according to the overlapping order from the two-dimensional code and then the text. For example, in a case where the two-dimensional code object is inserted after the text object is inserted in advance, the text object is inserted under the two-dimensional code object. On the other hand, also in a case where the text object is inserted after the two-dimensional code object is inserted in advance, the text object is inserted under the two-dimensional code object. Thus, the upper object setting window F33 allows the user to set a behavior of each object in a case of newly inserting.

That is, with the setting described above being performed every time the new object is inserted to the poster, it is impossible to perform an operation to hide the object including the important information, such as the two-dimensional code object, by the other object. Therefore, it is possible to prevent the object including the important information from being hidden by the other object while maintaining the design assumed by the user. In other words, as long as the user does not change the overlapping order intentionally, it is possible to prevent the object newly arranged by the user from overlapping with the important object. Therefore, the present disclosure can implement the intuitive operability and prevention of the loss of information.

### (Process of Setting Upper Object)

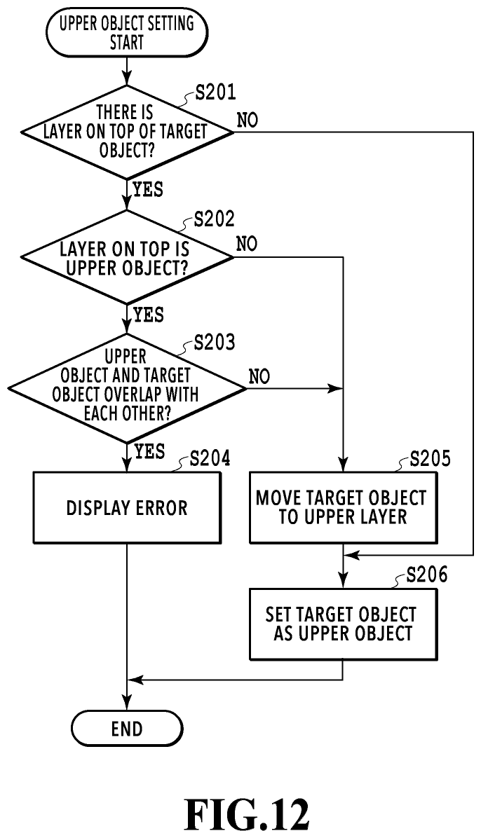

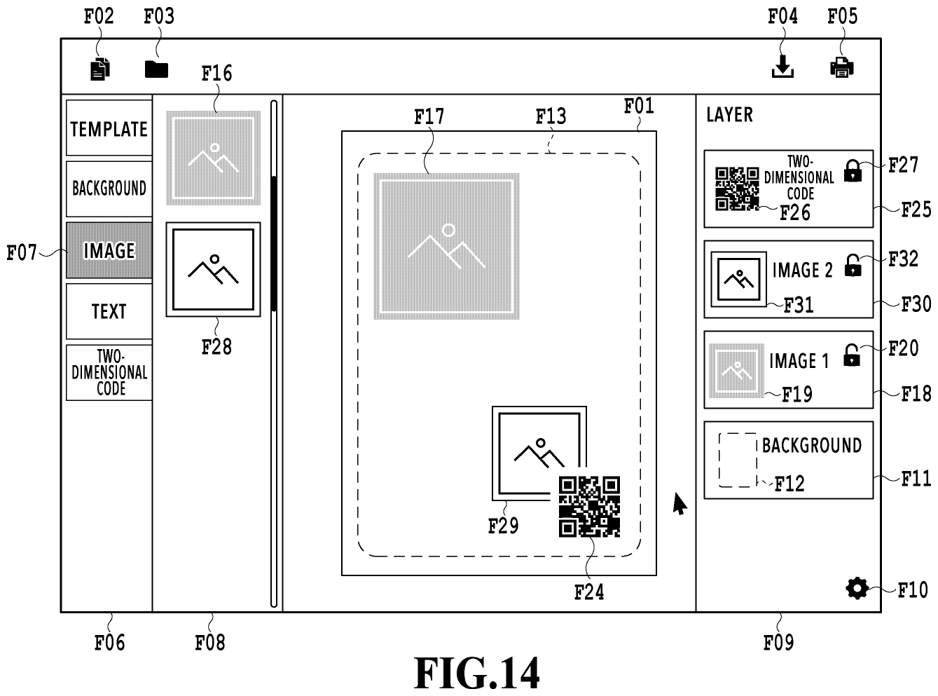

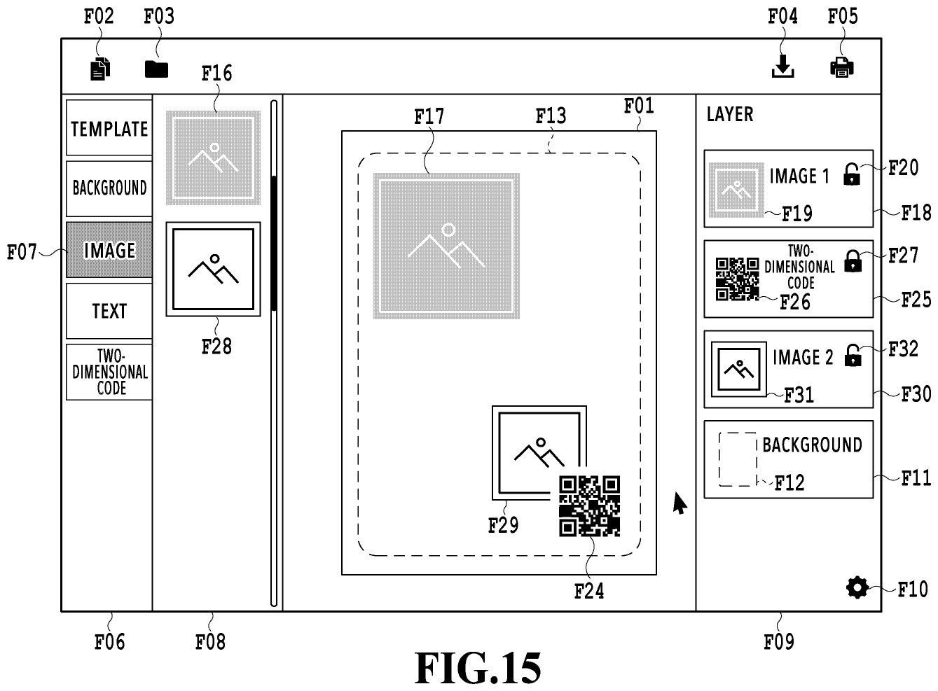

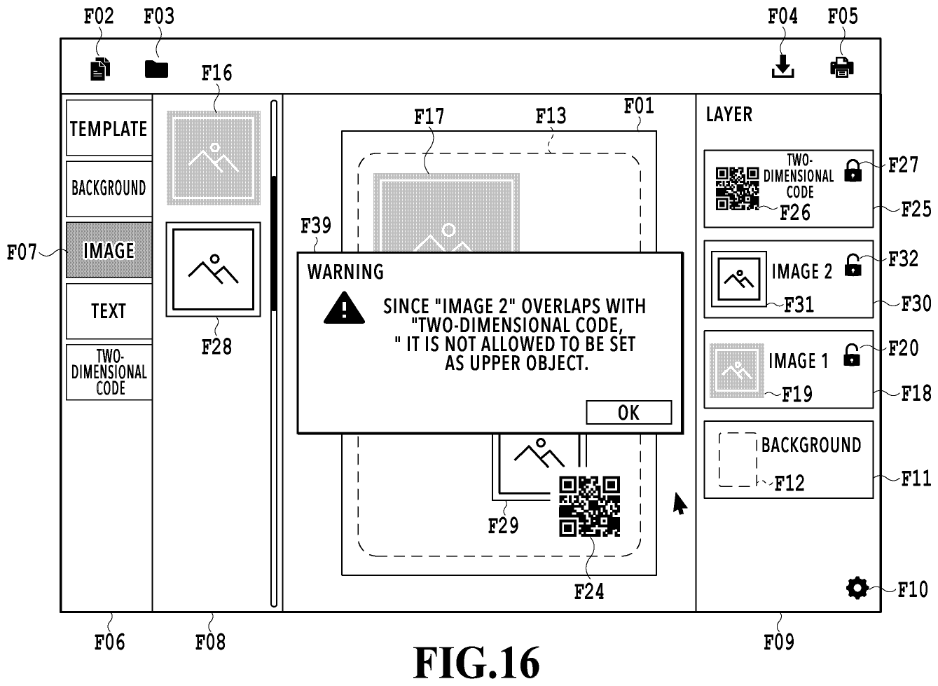

Subsequently, the process of setting the upper object is described with reference to FIGS. 12 to 16. FIG. 12 is a flowchart describing the process of setting the upper object. FIG. 13 is a diagram illustrating an example of a saving management table of the object laid out on the poster. FIG. 14 is a diagram illustrating an example of the Web application window in an operation to set the upper object in FIG. 12. In FIG. 14, the objects are arranged in a hierarchical manner in the order from the two-dimensional code, an image 2, the image 1, and the background sequentially from the top, and the layer F25 of the hierarchy of the two-dimensional code is set as the upper object. FIG. 15 is a diagram illustrating an example in which the upper object setting of the layer F18 transitions to the enabled state. FIG. 16 is a diagram illustrating a display example of an error dialog box F39.

The process illustrated in FIG. 12 is implemented with the CPU 11 reading out the program stored in the ROM 12 to the RAM 13 to execute. Specifically, the process illustrated in FIG. 12 is implemented with the CPU 11 reading out and executing the client program 21. More specifically, the process illustrated in FIG. 12 is executed in a timing in which the user presses the upper object setting button of an arbitrary layer and designates the upper object. Note that, a part of or all the functions of the steps in FIG. 12 may be implemented with hardware such as an ASIC or an electronic circuit. A sign “S” in description of each process means that it is a step in the corresponding flowchart. Additionally, it is possible to implement the process illustrated in FIG. 12 as a configuration of cloud computing in which a single function is shared by multiple resources and processed together via the Internet as long as the process of setting the upper object is implemented.

In S201, the CPU 11 determines whether there is the layer on top (an upper layer) of the target object as the operation target out of the multiple objects. If there is the layer on top (the upper layer) of the target object (S201 YES), the CPU 11 allows the process in S201 to proceed to process in S202. In S202, if the layer on top (the upper layer) is not the upper object (S202 NO), the CPU 11 allows the process in S202 to proceed to process in S205. If the layer on top (the upper layer) is the upper object (S202 YES), the CPU 11 allows the process in S202 to proceed to process in S203. In S203, if the upper object and the target object overlap with each other (S203 YES), the CPU 11 allows the process in S203 to proceed to process in S204. If the upper object and the target object do not overlap with each other (S203 NO), the CPU 11 allows the process in S203 to proceed to the process in S205. On the other hand, if there is no layer on top of the target object (S201 NO), the CPU 11 allows the process in S201 to proceed to process in S206. Note that, after the process in S204, the CPU 11 ends the processing of setting the upper object. Additionally, after the process in S205 and S206, the CPU 11 ends the processing of setting the upper object. Next, N a detailed example is described for each use case. In this case, top of the target object that is described above is used as a meaning indicating the layers F30 and F25 of the hierarchy higher than the layer F18 of the hierarchy of the target object in the arrangement rank of the target object in the area F09, for example. Additionally, the upper layer of the target object in the above description is used as a meaning indicating the layer in which the rank of the layer in the object management table in FIG. 2 is set higher. In any case, it is used as a meaning indicating a higher layer.

### (Use Case 1)

For example, in FIG. 14, a use case 1 in which the object F17 is the target object as the operation target and the upper object setting transitions from the disabled state to the enabled state by pressing the upper object setting icon F20 of the layer F18 is assumed. The CPU 11 confirms whether there is the layer on top of this target object (S201). For example, the layer F30 and the layer F25 are set on top of the layer F18 as the hierarchy of the target object. Additionally, out of the layer F30 and layer F25, the upper object setting of the layer F25 is set in the enabled state. Therefore, the CPU 11 allows the process to proceed to S202 YES and S203. Next, the CPU 11 determines whether the object F17 as the target object overlaps with the object F24 of the hierarchy of the layer F25 (S203). Referring to FIG. 13, the image 1 corresponding to the object F17 is at an X coordinate of 34 to 188 and a Y coordinate of 45 to 199. On the other hand, the two-dimensional code corresponding to the object F24 is at the X coordinate of 223 to 305 and the Y coordinate of 357 to 439. Therefore, a region of the object F17 and the region of the object F24 do not overlap with each other (S203 NO). Accordingly, as illustrated in FIG. 15, the CPU 11 moves the target object to the upper layer (S205), sets the target object as the upper object (S206), and ends the processing. In other words, in S203, as an execution condition of the control that does not allow the overlap, the CPU 11 performs process of determining whether a part of the region of the target object overlaps on top of a part of the region of the upper object. The control that does not allow the overlap is that, as described above, the control that is performed so that the target object as the operation target out of the multiple objects does not overlap on top of at least a part of the upper object. Note that, a method of moving the layer is not limited to the method of moving the target object to the top layer, and a method of moving the target object to be placed under the already-existing upper object may be applied.

### (Use Case 2)

For example, in FIG. 14, a use case 2 in which the object F29 is the target object as the operation target and the upper object setting transitions from the disabled state to the enabled state by pressing the upper object setting icon F32 of the layer F30 is assumed. The CPU 11 confirms whether there is the layer on top of the target object (S201). For example, the layer F25 is set on top of the layer F30 that is the hierarchy of the target object. Additionally, the upper object setting of the layer F25 is set in the enabled state. Therefore, the CPU 11 allows the process to proceed to S202 YES and S203. Next, the CPU 11 determines whether the object F29 as the target object overlaps with the object F24 of the hierarchy of the layer F25 (S203). Referring to FIG. 13, the image 2 corresponding to the object F29 is at the X coordinate of 160 to 260 and the Y coordinate is at 293 to 339. On the other hand, the two-dimensional code corresponding to the object F24 is at the X coordinate of 223 to 305 and the Y coordinate of 357 to 439. Therefore, at least a part of the region of the object F29 and the region of the object F24 overlap with each other (S203 YES). Accordingly, as illustrated in FIG. 16, the CPU 11 displays the error dialog box F39 notifying that the target object cannot be set as the upper object (S204), stops the processing of setting the upper object, and ends the processing. For example, as illustrated in FIG. 16, an error message notifying that “Since the “image 2” overlaps with the “two-dimensional code,” it is not allowed to be set as the upper object” is displayed in the error dialog box F39. In other words, in S204, the CPU 11 performs process of warning in a case where the editing operation to overlap with at least a part of the upper object is performed on the target object.

### (Process of Changing Overlapping Order)

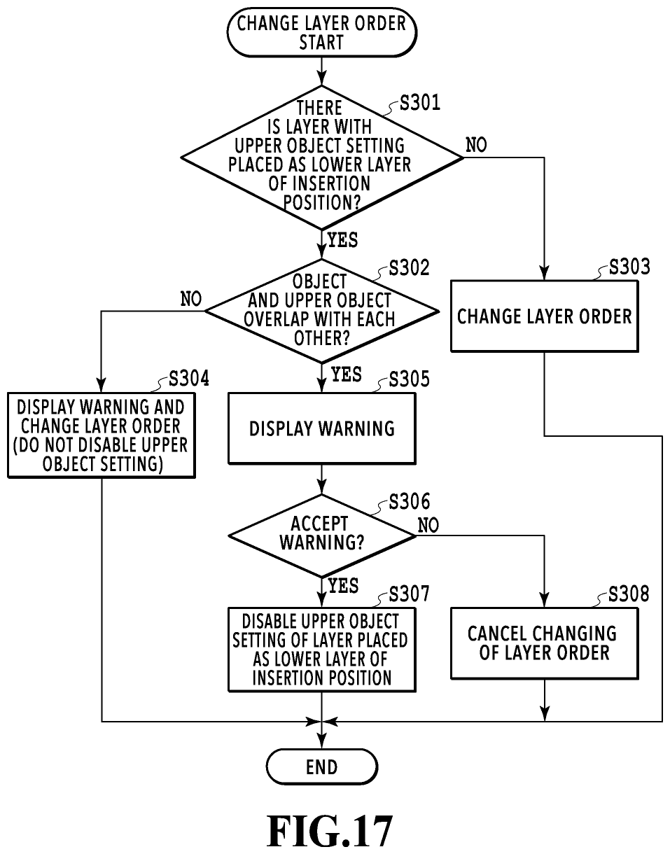

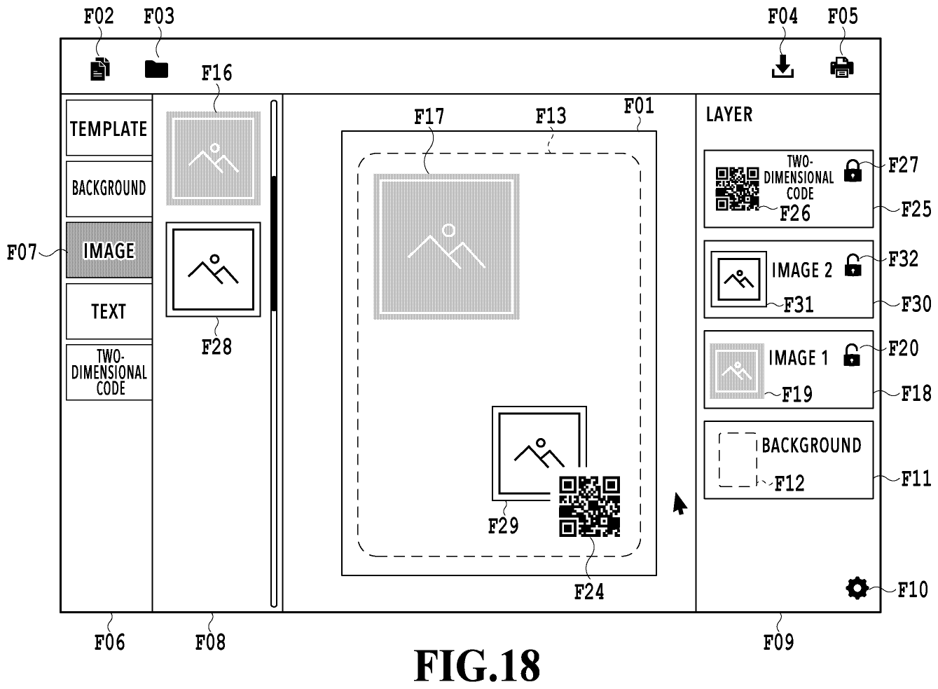

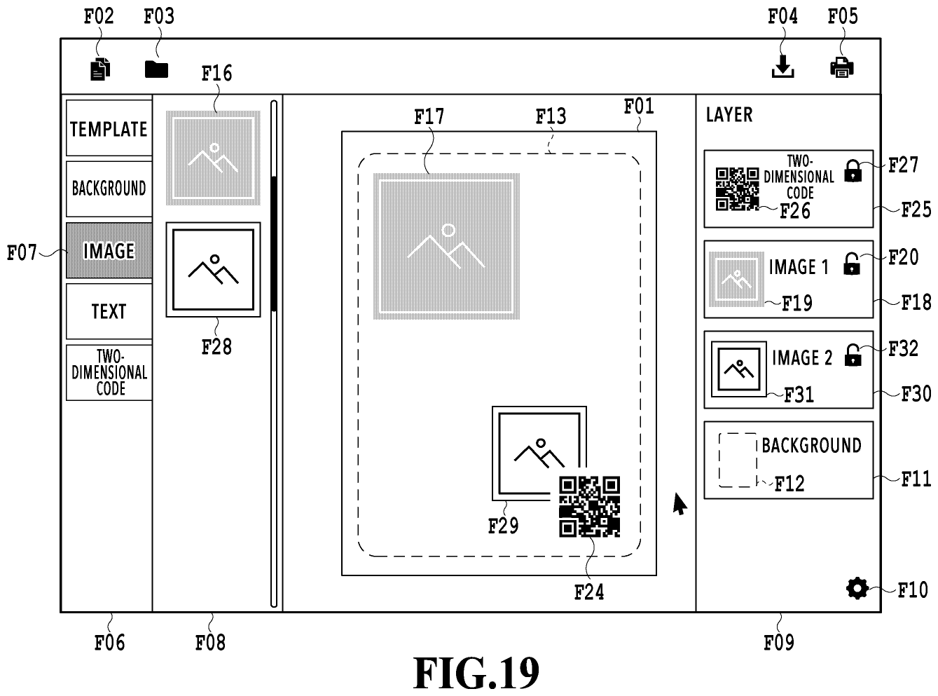

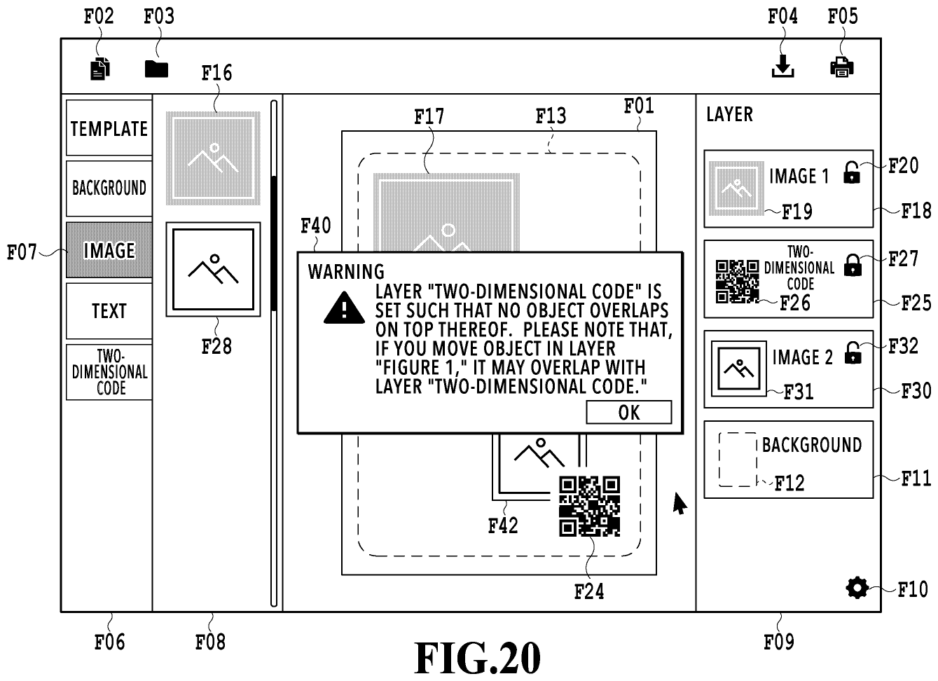

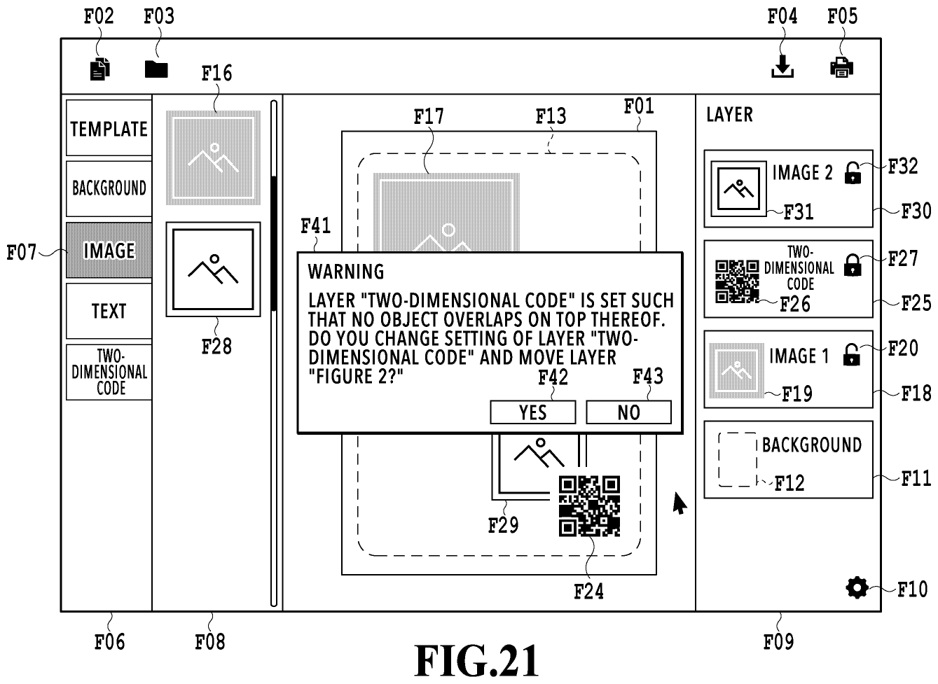

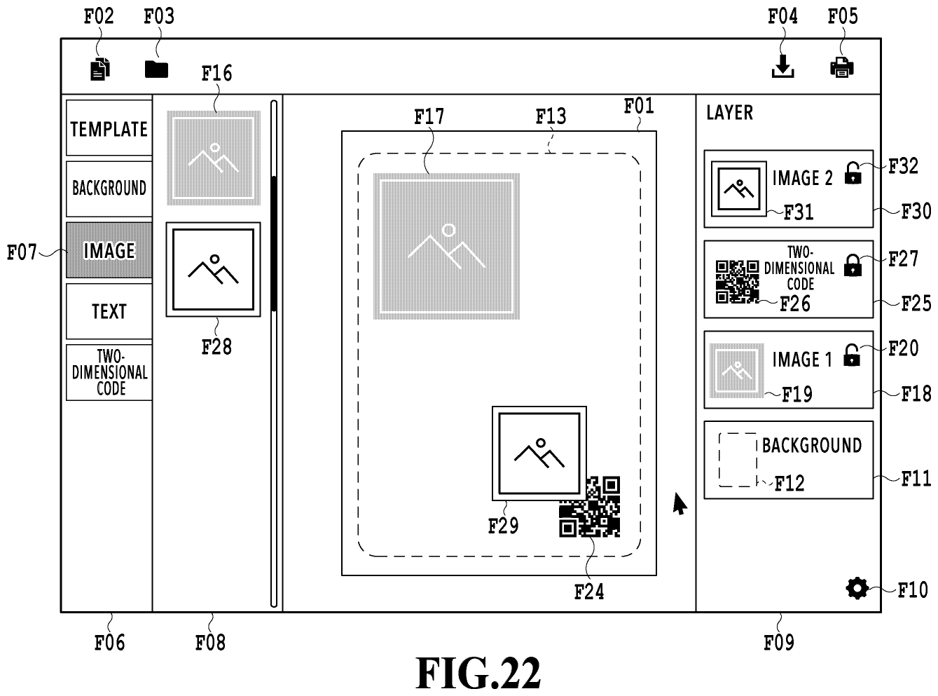

Subsequently, process of changing the overlapping order is described with reference to FIGS. 17 to 22. FIG. 17 is a flowchart describing the process of changing the overlapping order of the object. FIG. 18 is a diagram illustrating an example of the Web application window in the changing process in FIG. 17. In FIG. 18, the objects are arranged in a hierarchical manner in the order from the two-dimensional code, the image 2, the image 1, and the background sequentially from the top, and the layer F25 of the hierarchy of the two-dimensional code is set as the upper object. FIG. 19 is a diagram illustrating a changing example of the overlapping order of each object. FIG. 20 is a diagram illustrating a display example of an error dialog box F40. FIG. 21 is a diagram illustrating a display example of an error dialog box F41. FIG. 22 is a diagram illustrating a changing example of the overlapping order of each object.

The process illustrated in FIG. 17 is implemented with the CPU 11 reading out the program stored in the ROM 12 to the RAM 13 to execute. Specifically, the process illustrated in FIG. 17 is implemented with the CPU 11 reading out the client program 21 to execute. More specifically, the process illustrated in FIG. 17 is executed in a timing in which the user drags and drops the target object of an arbitrary layer and moves the target object on top of the arbitrary layer. Note that, a part of or all the functions of the steps in FIG. 17 may be implemented with hardware such as an ASIC or an electronic circuit. A sign “S” in description of each process means that it is a step in the corresponding flowchart. Additionally, it is possible to implement the process illustrated in FIG. 17 as a configuration of cloud computing in which a single function is shared by multiple resources and processed together via the Internet as long as the process of changing the overlapping order of the object is implemented.

In S301, based on the setting of the object arranged in the area F09, the CPU 11 determines whether the layer with the upper object setting is placed as the lower layer of (under) the insertion position of the target object. If there is the layer with the upper object setting is placed as the lower layer of (under) the insertion position (S301 YES), the CPU 11 allows the process in S301 to proceed to process in S302. On the other hand, if there is no layer with the upper object setting as the lower layer of (under) the insertion position (S301 NO), the CPU 11 allows the process in S301 to proceed to S303, and in S303, the CPU 11 changes the layer order and ends the process. In S302, the CPU 11 determines whether the target object and the upper object overlap with each other. That is, the CPU 11 determines whether the upper object is to be hidden by the target object. If the target object and the upper object overlap with each other (S302 YES), the CPU 11 allows the process in S302 to proceed to process in S305. In S305, the CPU 11 displays warning and allows the process in S305 to proceed to process in S306. In S306, the CPU 11 determines whether the warning is accepted. If the warning is accepted (S306 YES), the CPU 11 allows the process in S306 to proceed to process in S307. If the warning is not accepted (S306 NO), the CPU 11 allows the process in S306 to proceed to S308. In S307, the CPU 11 disables the upper object setting of the layer of the lower layer of (under) the insertion position and ends the processing. In S308, the CPU 11 cancels changing of the layer order and ends the processing. On the other hand, if the target object and the upper object do not overlap with each other (S302 NO), the CPU 11 allows the process in S302 to proceed to process in S304. In S304, the CPU 11 displays warning, changes the layer order, and ends the processing. In this case, under the target object that is described above is used as a meaning indicating the layers F18 and F11 of the hierarchy lower than the layer F30 of the hierarchy of the target object in the arrangement rank of the target object in the area F09, for example. Additionally, the lower layer of the target object in the above description is used as a meaning indicating the layer in which the rank of the layer in the object management table in FIG. 2 is set lower. In any case, it is used as a meaning indicating a lower layer. Note that, in the process in S304, the upper object setting is not disabled. Next, a partial detailed example of the changing process is described for each use case.

### (Use Case A)

For example, in FIG. 18, a use case A in which the object F29 included in the hierarchy of the layer F30 is the target object and the layer F30 is moved to the upper layer of the layer F25 is assumed. In a case of the use case A, once the layer F30 is moved to the upper layer of the layer F25, it is a state in which the layer F25 is in the lower layer of the layer F30. Additionally, the upper object setting of the layer F25 is set in the enabled state. Therefore, the CPU 11 allows the process to proceed from S301 YES to S302. Next, the CPU 11 determines whether the object F24 included in the hierarchy of the layer F25 is to be hidden by the object F29 included in the hierarchy of the layer F30 (S302). A detailed example of the subsequent process in the use case A is described as use cases D1 and D2.

### (Use Case B)

For example, in FIG. 18, a use case B in which the object F17 included in the hierarchy of the layer F18 is the target object and the layer F18 is moved to the upper layer of the layer F30 is assumed. In a case of the use case B, once the layer F18 is moved to the upper layer of the layer F30, it is a state in which the layer F30 is in the lower layer of the layer F18. Additionally, the upper object setting of the layer F30 is set in the disabled state. Therefore, the CPU 11 allows the process to proceed from S301 NO to S303. Next, the CPU 11 changes the layer order by moving the layer F18 to the upper layer of the layer F30 and completes the processing of changing the overlapping order. FIG. 19 illustrates an example after the layer F18 is moved to the upper layer of the layer F30.

### (Use Case C)

For example, in FIG. 18, a use case C in which the object F17 included in the hierarchy of the layer F18 is the target object and the layer F18 is moved to the upper layer of the layer F25 is assumed. In a case of the use case C, once the layer F18 is moved to the upper layer of the layer F25, it is a state in which the layer F25 is in the lower layer of the layer F18. Additionally, the upper object setting of the layer F25 is set in the enabled state. Therefore, the CPU 11 allows the process to proceed from S301 YES to S302. Next, the CPU 11 determines whether the object F24 included in the hierarchy of the layer F25 is to be hidden by the object F17 included in the hierarchy of the layer F18 (S302). Since it is determined that the object F24 included in the hierarchy of the layer F25 is not to be hidden by the object F17 included in the hierarchy of the layer F18 (S302 NO), the CPU 11 allows the process in S302 to proceed to the process in S304. In S304, as illustrated in FIG. 20, the CPU 11 displays the error dialog box F40 as the warning and completes the process of changing the overlapping order. The error dialog box F40 displays “The layer ‘two-dimensional code’ is set such that no object overlaps on top thereof. Please note that, if you move the object in a layer ‘FIG. 1,’ it may overlap with the layer ‘two-dimensional code’.” Note that, the “FIG. 1” corresponds to the “image 1.” Additionally, the CPU 11 does not cancel the upper object setting of the layer F25.

### (Use Case D1)

The use case D1 in which the object F29 is the target object, the layer F30 of the hierarchy of the object F29 is moved to the upper layer of the layer F25, and the warning is accepted is assumed. It is determined that the object F24 included in the hierarchy of the layer F25 is to be hidden by the object F29 included in the hierarchy of the layer F30 (S302 YES). Subsequently, as illustrated in FIG. 21, the CPU 11 displays the error dialog box F41 as the warning and allows the process in S305 to proceed to the process in S306. The error dialog box F41 displays “The layer ‘two-dimensional code’ is set such that no object overlaps on top thereof. Do you change the setting of the layer ‘two-dimensional code’ and move a layer ‘FIG. 2’?” Note that, the “FIG. 2” corresponds to the “image 2.” Additionally, a button F42 and a button F43 are arranged in the error dialog box F41. The button F42 displays a text indicating “Yes.” Therefore, with the user pressing the button F42, the process of accepting the warning is executed. Specifically, in response to the pressing of the button F42, the CPU 11 determines that the user accepts the warning (S306 YES). Subsequently, as illustrated in FIG. 22, the CPU 11 cancels the upper object setting of the layer F25 by allowing the enabled state to transition to the disabled state (S307). With this process, the CPU 11 inserts the layer F30 to the upper layer of the layer F25 and completes the processing of changing the overlapping order. In other words, the CPU 11 displays the contents of the warning on the editing window of the multiple objects and performs process of canceling the setting of the upper object. Additionally, the warning includes contents indicating that the editing operation corresponds to the control that does not allow the overlap and contents indicating that the control to cancel the setting of the upper object is performed. Moreover, in a case where an operation to accept the warning is performed, the CPU 11 cancels the setting of the upper object and performs the process of changing the overlapping order of the upper object and the target object.

### (Use Case D2)

The use case D2 in which the object F29 is the target object, the layer F30 of the hierarchy of the object F29 is moved to the upper layer of the layer F25, and the warning is not accepted is assumed. The button F43 displays a text “No.” Therefore, with the user pressing the button F43, process of not accepting the warning is executed. Specifically, in response to the pressing of the button F43, the CPU 11 determines that the user does not accept the warning (S306 NO), cancels the process of inserting the layer F30 (S308), discards the process of changing the overlapping order, and restores the state to the original state as illustrated in FIG. 18. In other words, in a case where an operation to reject the warning is performed, the CPU 11 performs the process of canceling the operation to change the overlapping order of the upper object and the target object.

Additionally, the process of changing the overlapping order as described above is performed every time the user performs the operation to change the overlapping order.

### (Confirmation Process Before Printing Execution)

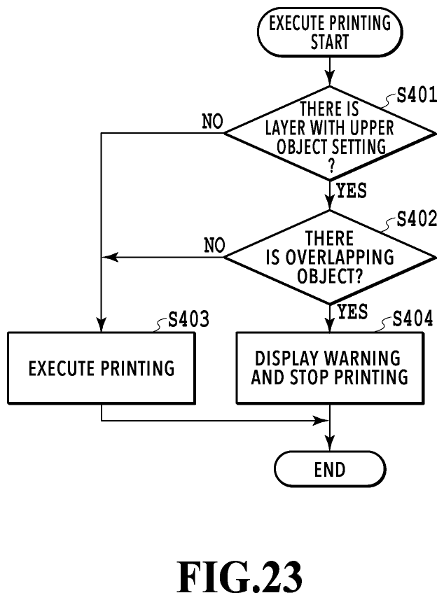

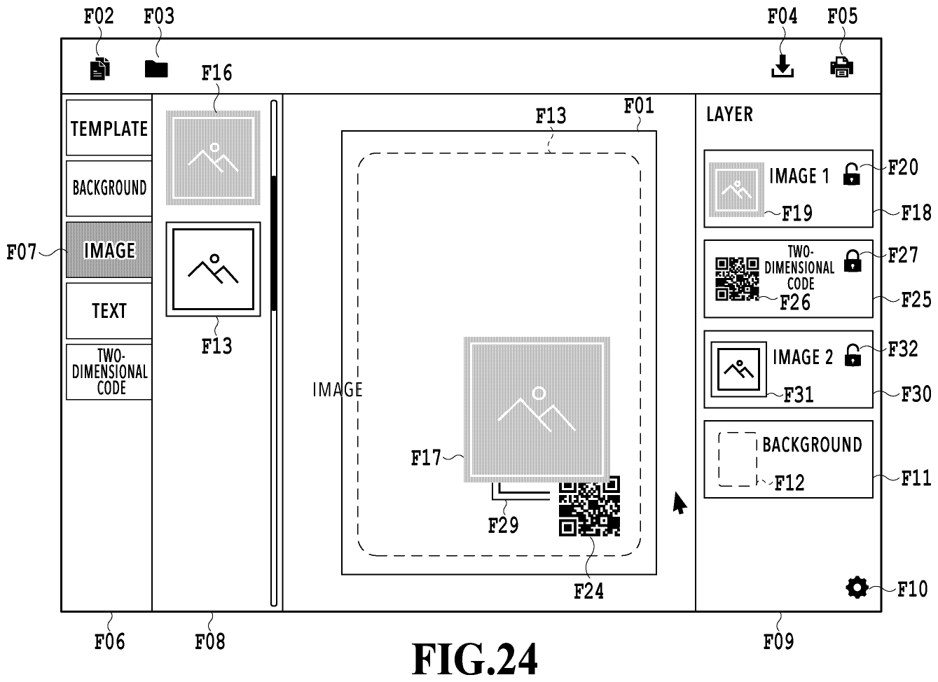

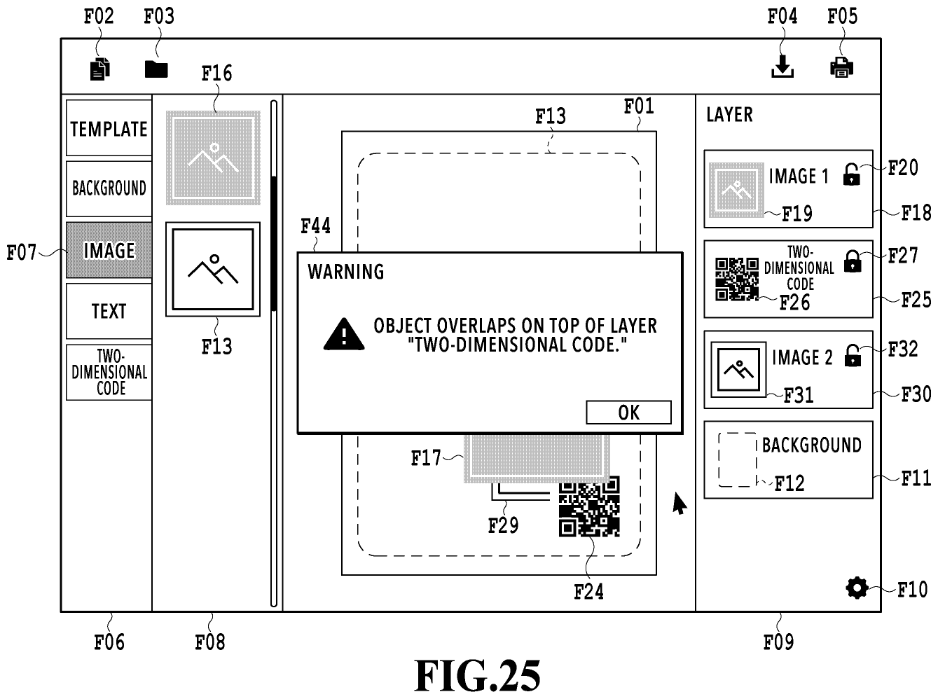

Confirmation process before printing execution is described with reference to FIGS. 23 to 25. FIG. 23 is a flowchart describing the confirmation process before the printing execution of the poster. FIG. 24 is a diagram illustrating an example of the Web application window in a case of the printing execution of the poster. In FIG. 24, the objects are arranged in a hierarchical manner from the image 1, the two-dimensional code, the image 2, and the background sequentially from the top, and the layer F25 of the hierarchy of the two-dimensional code is set as the upper object. FIG. 25 is a diagram illustrating a display example of an error dialog box F44.

The process illustrated in FIG. 23 is implemented with the CPU 11 reading out the program stored in the ROM 12 to the RAM 13 to execute. Specifically, the process illustrated in FIG. 23 is implemented with the CPU 11 reading out the client program 21 to execute. More specifically, the process illustrated in FIG. 23 is executed in a timing in which the user presses the button F05 and operates an execution instruction of printing. Note that, a part of or all the functions of the steps in FIG. 23 may be implemented with hardware such as an ASIC or an electronic circuit. A sign “S” in description of each process means that it is a step in the corresponding flowchart. Additionally, it is possible to implement the process illustrated in FIG. 23 as a configuration of cloud computing in which a single function is shared by multiple resources and processed together via the Internet as long as the confirmation process before the printing execution is implemented.

In S401, based on the setting of the object arranged in the area F09, the CPU 11 determines whether the poster being edited by the user includes the upper object. That is, in S401, the CPU 11 determines whether there is the layer with the upper object setting. If there is the layer with the upper object setting (S401 YES), the CPU 11 allows the process in S401 to proceed to process in S402. On the other hand, if there is no layer with the upper object setting (S401 NO), the CPU 11 allows the process in S401 to proceed to process in S403, and in S403, the CPU 11 executes printing and ends the processing. Subsequently, in S402, the CPU 11 determines whether the upper object is hidden depending on whether the poster being edited includes the upper object. That is, in S402, if there is the overlapping object (S402 YES), the CPU 11 allows the process in S402 to proceed to process in S404. On the other hand, if there is no overlapping object (S402 NO), the CPU 11 allows the process in S402 to the process in S403, and in S403, the CPU 11 executes printing and ends the processing. Subsequently, in S404, the CPU 11 displays the warning in response to hiding of the upper object and stops printing. Next, a detailed example of the confirmation process before the printing execution is described.

For example, in the example in FIG. 24, the upper object setting of the layer F25 is set in the enabled state (S401 YES). Therefore, the CPU 11 allows the process in S401 to proceed to the process in S402. As illustrated in FIG. 24, a part of the object F17 included in the hierarchy of the layer F18 overlaps a part of the object F24 (the two-dimensional code object) included in the hierarchy of the layer F25. Therefore, a part of the two-dimensional code object is hidden by a part of the object F17. Accordingly, the CPU 11 determines that there is the overlapping object (S402 YES) and allows the process in S402 to proceed to the process in S404. In S404, as illustrated in FIG. 25, the CPU 11 displays the error dialog box F44 and stops printing. The error dialog box F44 displays “The object overlaps on top of the layer ‘two-dimensional code’.” That is, in response to the pressing of the button F05, the information processing system 1 displays the error dialog box F44 in FIG. 25 to warn the user that the object overlaps with the upper object and stops printing. In other words, in a case where the editing operation to overlap with a part of the upper object is performed on the target object, the CPU 11 does not reflect the contents of the editing operation to the printing operation. Specifically, in a case where an operation to instruct to print the image including the multiple objects is performed in a state in which a part of the region of the target object overlaps with a part of the region of the upper object, the CPU 11 issues warning and stops printing as process of not reflecting to the printing operation.

Additionally, the confirmation process before the printing execution as described above prevents the unintended overlapping of the object with the upper object by being performed every time the printing execution is instructed. The above is a flow of a series of process of the present embodiment.

### (Effects)

As described above, in the present embodiment, in a case where the user adds the new object to the poster, whether the poster includes the upper object is determined. According to the fact that the upper object is included, the new object is inserted under the upper object. Thus, as long as the overlapping order is not changed intentionally, it is possible to prevent the object newly arranged by the user from overlapping with the important object. Therefore, it is possible to implement the intuitive operability and prevention of the loss of the information. Accordingly, it is possible to improve the usability in the design application.

Additionally, also in a case where the overlapping order is further changed, if the upper object is not to be hidden in a case of trying to move the layer on top of (the upper layer) the upper object, the moved object is allowed to be arranged on top of (the upper layer) the upper object. Moreover, whether the upper object is not hidden is confirmed again in a case of printing. In a case where the upper object is to be hidden, the warning is displayed, and the setting of the upper object canceled, or the changing of the overlapping order is canceled. Thus, it is possible to prevent the object from unintentionally overlapping with the upper object, and it is possible to suppress misprinting by the user. Accordingly, it is possible to suppress generation of waste sheet, and it is possible to reduce waste of resources.

Moreover, although a configuration example in which the user is allowed to manually select the insertion position of the object in a case of moving the layer on top of (the upper layer) the upper object is described, a method of controlling the insertion position of the object is not limited thereto, and another method may be applied. For example, it is possible to replace a configuration in which the warning is displayed depending on the operation to change the overlapping order with a configuration in which the insertion of the layer on top of (the upper layer) the upper object is all rejected. For example, in the example in FIG. 18, in a case where an arbitrary layer is dragged on top of (the upper layer) the upper object represented by F25, a message notifying that a drop operation is rejected may be displayed. Note that, a method of expressing the notification that the changing of the overlapping order is rejected is not limited thereto, and an arbitrary icon and pop-up may be used. Alternatively, an alarm with sound such as a beep may be provided. Alternatively, a notification that the changing of the overlapping order is rejected may be provided to a smartphone. Also in this case, as with the above-described configuration, an effect that it is possible to prevent the object from unintentionally overlapping with the upper object is achieved.

### OTHER EMBODIMENTS

Various examples and embodiments of the present disclosure are described above; however, the intent and the scope of the present disclosure are not limited to the specific description in the present specification. The present disclosure is not limited to the above-described embodiments, and various modifications may be applied.

Additionally, the present disclosure may be an appropriate combination of a part of the above-described embodiments.

### (Modification 1)

For example, although an example in which the single printer 15 is provided in the information processing system 1 is described, it is not particularly limited thereto. For example, multiple printers 15 may be provided in the information processing system 1, and the client terminal 10 may designate an arbitrary printer 15 from the multiple printers 15 as a transmission destination of the printing data. Specifically, only a specific model of the printer 15 may be selectable from the Web browser 18.

### (Modification 2)

Additionally, for example, although an example in which the printer 15 is a constituent in the information processing system 1 that can be connected to the client terminal 10 via the network 22 is described, it is not particularly limited thereto. For example, the printer 15 may be outside the information processing system 1 via the network 22. That is, the client terminal 10 can also transmit the printing data and cause the printer 15 outside the information processing system 1 to perform printing.

### (Modification 3)

Moreover, for example, although a configuration example in which the single layer corresponds to the single object is described, it is not particularly limited thereto. For example, a configuration in which the single layer corresponds to the multiple objects may be applied. Specifically, a single great layer may include multiple small layers, and the object may correspond to each of the multiple small layers. In this case, the great layer itself may be processed as the single layer.

### (Modification 4)

Furthermore, for example, although an operation in a case where the operation that hides the object including the important information by the other object is not allowed and cannot be performed in the first place and an operation in a case where the above operation can be performed but the warning is issued are described, it is not particularly limited thereto. For example, the above operation may be performed on the Web application window but may not be reflected on the Web application 3 side. Specifically, the operation performed on the Web application window may be returned to the Web application window in a state before the operation after a predetermined elapsed time.

### (Modification 5)

Additionally, for example, although a configuration example of the information processing system 1 in which the client terminal 10 and the server system 2 are connected to each other via the network 22 is described, it is not particularly limited thereto. For example, the client terminal 10 may implement the process of the present disclosure individually. In this case, the client terminal 10 may be formed as a stand-alone type terminal. Additionally, in this case, the configuration of the Web application 3 may be implemented in the client terminal 10.

### (Modification 6)

Moreover, for example, although an example in which the client terminal 10 is formed of a general personal computer or smartphone is described, it is not particularly limited thereto. The client terminal 10 may be a terminal that functions as a terminal that can be connected with the server system 2 via the network 22. For example, the client terminal 10 may be a television receiver, an imaging apparatus, a home electric appliance, an automobile, a smartwatch, or smart glasses that can be connected with the server system 2 via the network 22.

### (Modification 7)

Furthermore, for example, although an example in which the network 22 is the Internet is described, it is not particularly limited thereto. The network 22 may be a mobile communication network implemented by a mobile communication system such as 5G (the fifth-generation mobile communication system) and 6G (the sixth-generation mobile communication system). Alternatively, the network 22 may be Internet of Things (IoT) network. Alternatively, the network 22 may be a controller area network (CAN).

### (Modification 8)

Additionally, for example, although an example in which various warnings are displayed on the Web application window is described, it is not particularly limited thereto. For example, a notification of the warning may be provided to a smartphone or a smartwatch.

Moreover, although a preferable embodiment of the present invention is described, it is needless to say that the present invention is not limited to this embodiment, and various modifications and changes may be applied within the scope of the gist. The various characteristics of the above-described embodiments may be used individually or in combination of some of them.

For example, instead of the process of displaying the error in S204 in FIG. 12, the process in S305 to S308 in FIG. 17 may be incorporated. Alternatively, instead of the process in S305 to S308 in FIG. 17, the process of displaying the error in S204 in FIG. 12 may be incorporated.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-095372, filed on Jun. 12, 2024, which is hereby incorporated by reference herein in its entirety.

What is claimed is:

1. A control method causing a computer to execute:
arranging to perform hierarchical arrangement in which a plurality of objects are arranged in a hierarchical manner;
setting an object arranged on a top hierarchy out of the plurality of objects, on which the hierarchical arrangement is performed, as an upper object; and
controlling a control not to allow a target object as an operation target to be operated out of the plurality of objects to overlap on top of at least a part of the upper object.

2. The control method according to claim 1, wherein
the controlling includes, as the control not to allow the target object to overlap, rejecting an editing operation to overlap on at least a part of the upper object to be performed on the target object.

3. The control method according to claim 1, wherein
the controlling includes, as the control not to allow the target object to overlap, not reflecting contents of an editing operation to a printing operation in a case where the editing operation to overlap on at least a part of the upper object is performed on the target object.

4. The control method according to claim 1, wherein
the controlling includes, as the control not to allow the target object to overlap, issuing a warning in a case where an editing operation to overlap on at least a part of the upper object is performed on the target object.

5. The control method according to claim 4, wherein
the controlling is an operation to change an overlapping order of the upper object and the target object as the editing operation, including displaying contents of the warning on an editing window of the plurality of objects and canceling setting of the upper object.

6. The control method according to claim 1, wherein
the controlling includes, as an execution condition of the control not to allow the target object to overlap, determining whether a part of a region of the target object overlaps on top of a part of a region of the upper object.

7. The control method according to claim 4, wherein
the warning includes contents indicating that the editing operation corresponds to the control not to allow the target object to overlap and contents indicating that control to cancel setting of the upper object is performed, and
the controlling is an operation to change an overlapping order of the upper object and the target object as the editing operation, and in a case where an operation to accept the warning is performed, the setting of the upper object is canceled, and the overlapping order of the upper object and the target object is changed.

8. The control method according to claim 4, wherein
the warning includes contents indicating that the editing operation corresponds to the control not to allow the target object to overlap and contents indicating that control to cancel setting of the upper object is performed, and
the controlling is an operation to change an overlapping order of the upper object and the target object as the editing operation, and in a case where an operation to reject the warning is performed, the operation to change the overlapping order of the upper object and the target object is canceled.

9. The control method according to claim 3, wherein
the controlling includes, in a case where an operation to instruct to perform printing of an image including the plurality of objects in a state in which a part of a region of the target object overlaps on a part of a region of the upper object, issuing a warning and interrupts the printing as process of not reflecting to the printing operation.

10. The control method according to claim 1, wherein
the setting includes determining whether to set as the upper object in accordance with a type of each of the plurality of objects.

11. The control method according to claim 1, wherein
in the controlling, in a case where editing of one of the plurality of objects is started as a new object in a state in which the upper object is set, the new object is inserted underneath the upper object.

12. The control method according to claim 1, wherein
in the arranging, a layer including the object is set for each object, and a hierarchization to overlap the layers sequentially is performed as the hierarchical arrangement

13. A non-transitory computer-readable storage medium storing a program that causes a computer to execute:
arranging to perform hierarchical arrangement in which a plurality of objects are arranged in a hierarchical manner;
setting an object arranged on a top hierarchy out of the plurality of objects, on which the hierarchical arrangement is performed, as an upper object; and
controlling a control not to allow a target object as an operation target to be operated out of the plurality of objects to overlap on top of at least a part of the upper object.

14. An information processing apparatus, comprising:
an arrangement unit configured to perform hierarchical arrangement in which a plurality of objects are arranged in a hierarchical manner;
a setting unit configured to set an object arranged on a top hierarchy out of the plurality of objects, on which the hierarchical arrangement is performed, as an upper object; and
a control unit configured to perform a control not to allow a target object as an operation target to be operated out of the plurality of objects to overlap on top of at least a part of the upper object.
